(19) United States
(12) Patent Application Publication
(10) Pub. No.: US 2021/0281387 A1
(43) Pub. Date: Sep. 9, 2021

(54) SAMPLING APPARATUS FOR DETECTING A STARTING BYTE IN A HIGH-FREQUENCY SERIAL DATA STREAM

(71) Applicant: FRABA B.V., SG HEERLEN (NL)

(72) Inventors: UWE KETTERING, KOELN (DE); MATTHIAS LANSING, AACHEN (DE)

(73) Assignee: FRABA B.V., SG HEERLEN (NL)

(21) Appl. No.: 17/258,450

(22) PCT Filed: Jul. 11, 2018
(86) PCT No.: PCT/EP2018/068800

§ 371 Date: Jan. 7, 2021

(51) Int. Cl. H04L 7/00

(52) U.S. Cl. CPC H04L 7/0087

(57) ABSTRACT

A scanning apparatus for detecting a start byte in a high-frequency serial data stream. The scanning apparatus includes a detection unit and a clock signal generator. The detection unit detects the start byte in the high-frequency serial data stream. The detection unit only includes an independent logic detection circuit which only includes temperature-insensitive circuit elements and which excludes addition blocks. The clock signal generator provides the detection unit with a high-frequency clock signal which is synchronized to the high-frequency serial data stream. The high-frequency clock signal is provided with a frequency which is higher than a frequency of the high-frequency serial data stream.

### CROSS REFERENCE TO PRIOR APPLICATIONS

This application is a U.S. National Phase application under 35 U.S.C. § 371 of International Application No. PCT/EP2018/068800, filed on Jul. 11, 2018. The International Application was published in German on Jan. 16, 2020 as WO 2020/011347 A1 under PCT Article 21(2).

### FIELD

The present invention relates to a scanning apparatus for detecting a start byte in a high-frequency serial data stream, in particular a scanning apparatus for an absolute position measuring device, comprising a detection unit which is configured to detect the start byte in the data stream and a clock signal generator which is configured to provide to the detection unit with a high-frequency clock signal synchronized to the data stream, wherein the clock signal is provided with a higher frequency than the data stream.

### BACKGROUND

Absolute position measuring devices are currently used which, for example, generate absolute measuring values that are transmitted to a subsequent logic device via a digital, mostly serial interface. It is further often necessary to transmit commands from the subsequent electronic device to the position measuring device via the serial data interface for triggering events. A typical serial data interface for the data transmission between the position measuring device and the subsequent electronic device is the disclosed BiSS interface which uses the BiSS line protocol. An endless data stream with a high frequency of 6.25 MHz, for example, is here transmitted between the position measuring device and the subsequent electronic device. In a no-load operation, a master, which is generally the subsequent electronic device, continuously sends a no-load data stream to a slave, which is generally the position measuring device, for avoiding electrostatic charging of the interface and for ensuring a common-mode-free data line of the interface. At a random point of time, the master interrupts the no-load-data stream and sends a start byte for signaling the start of a data transmission. This start byte must be detected by the scanning apparatus of the slave to allow for an evaluation of the data subsequently transmitted in the data stream.

A position measuring device with such a scanning apparatus is described, for example, in DE 10 2014 212 288 A1. The scanning apparatus comprises a detection unit as well as a clock signal generator. The scanning apparatus is configured to detect a start byte in a high-frequency serial data stream provided by a subsequent electronic device via a serial data interface. The clock signal generator provides to the detection unit with a clock signal which is synchronized to the data stream. The detection unit scans the data stream at the clock rate of the clock signal for detecting a start byte in the data stream.

The scanning apparatus is typically defined by a so-called field programmable gate array (FPGA). A FPGA is an integrated circuit into which logic circuits can be programmed. FPGAs allow for realizing complex digital circuits and a very rapid scanning of the data stream as is required for the start byte detection in high-frequency serial data streams. The scanning must here be performed at a frequency which is considerably higher than the frequency of the data stream to allow for a reliable start byte detection. The scanning is often performed at twice the frequency of the data stream. Depending on the field of application of the position measuring device, operating temperatures of up to approximately 115° C. can occur. Special high temperature-resistant FPGAs are required to allow for a reliable start byte detection in the scanning apparatus at such high operating temperatures which are, however, expensive.

### SUMMARY

An aspect of the present invention is to provide an inexpensive scanning apparatus which allows for a reliable start byte detection in a high-frequency serial data stream at high temperatures.

In an embodiment, the present invention provides a scanning apparatus for detecting a start byte in a high-frequency serial data stream. The scanning apparatus includes a detection unit and a clock signal generator. The detection unit is configured to detect the start byte in the high-frequency serial data stream. The detection unit consists of an independent logic detection circuit which consists of temperature-insensitive circuit elements and which excludes addition blocks. The clock signal generator is configured to provide the detection unit with a high-frequency clock signal which is synchronized to the high-frequency serial data stream. The high-frequency clock signal is provided with a frequency which is higher than a frequency of the high-frequency serial data stream.

### BRIEF DESCRIPTION OF THE DRAWINGS

The present invention is described in greater detail below on the basis of embodiments and of the drawings in which:

FIG. 1 shows a schematic circuit diagram of a scanning apparatus according to the present invention; and

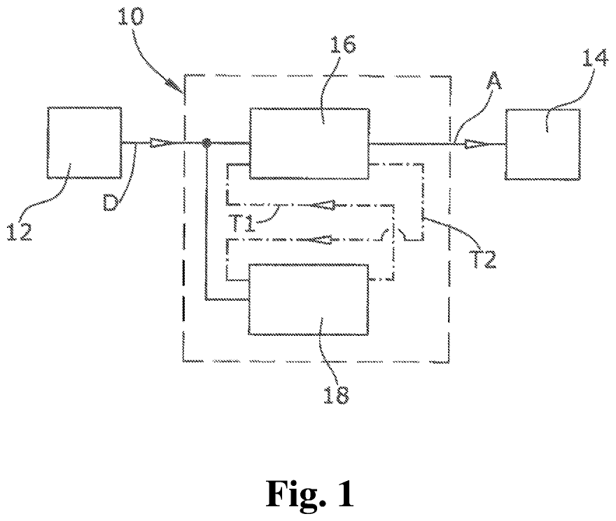

FIG. 2 shows a schematic circuit diagram of a detection unit of the scanning apparatus of FIG. 1.

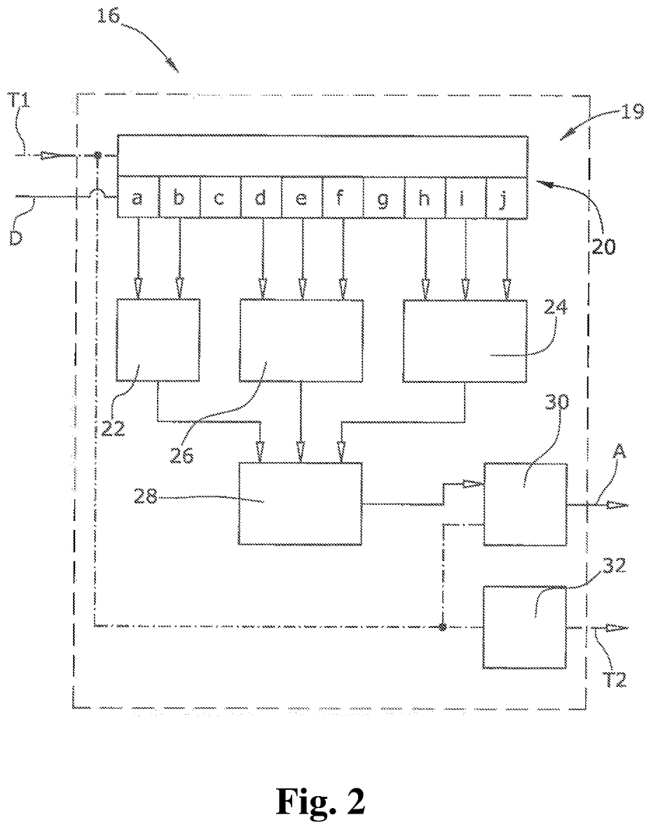

### DETAILED DESCRIPTION

According to the present invention, the high-frequency detection unit of the scanning apparatus is defined by an independent logic detection circuit which excludes addition blocks. The detection circuit comprises only temperature-insensitive circuit elements. The detection circuit in particular does not comprise any temperature-sensitive and/or cost-intensive addition blocks which are usually present in FPGAs. The scanning apparatus according to the present invention allows for a reliable start byte detection even at high temperatures of up to 115° C. and can be realized in an inexpensive manner.

Conventional microcontrollers typically comprise an integrated clock generator which can generate clock signals at the high clock rates required for a reliable start byte detection. The clock signal generator is, for example, therefore defined by a microcontroller, whereby an inexpensive configuration of the scanning apparatus according to the present invention is feasible.

In an embodiment of the present invention, the detection unit can, for example, be defined by an integrated circuit. The scanning device can thereby be particularly compact and inexpensive.

The detection unit is advantageously configured to provide the clock signal generator with a feedback clock signal. This allows for a particularly exact synchronization between the data stream and the clock signal and thus for a particularly reliable start byte detection in the detection unit.

In an embodiment of the present invention, the detection unit can, for example, comprise a shifting register element with n memory locations and a plurality of lookup table elements (LUTs). The shifting register element here serves as a data buffer for buffering the data stream bits for the start byte detection. Shifting register elements shift their memory contents by one memory location during each operating cycle and are thus particularly suitable for processing serial data streams. The data stream bits received last are here always stored in the shifting register element. The number n of the memory locations of the shifting register element here corresponds to the number of bits of the start byte to be detected. Shifting register elements are of a simple setup and can reliably operate at high clock rates and at high temperatures. LUTs allow for a simple comparison of the data buffered in the shifting register element with the bit sequence predetermined by the start byte. The LUTs are here configured so that they respectively compare a specific portion of the buffered data with a corresponding start byte portion. The use of a plurality of LUTs allows for a particularly reliable start byte detection. The detection unit with a shifting register element and a plurality of LUTs allows for an inexpensive and reliable configuration of the scanning apparatus according to the present invention.

In an embodiment of the present invention, the lookup table elements can, for example, be configured so that a maximum of n−1 memory locations of the shifting register are evaluatable. Not all data stream bits buffered in the shifting register element are consequently compared with the corresponding start byte bits for detecting a start byte. Some bits are intentionally ignored to allow for a tolerance with regard to faults in the data transmission. This allows for a reliable start byte detection even in the case of a temporary malfunction of the data stream transmission.

An exemplary embodiment of a scanning apparatus for detecting a start byte in a high-frequency serial data stream according to the present invention is described below under reference to the accompanying drawings.

The scanning apparatus 10 according to the present invention can, for example, be used in a position measuring device (which is not shown in detail). The scanning apparatus 10 is provided with a high-frequency serial data stream D from an external master apparatus 12, for example, from a subsequent electronic device. In the present exemplary embodiment, the high-frequency serial data stream D is 8b10b-coded and has a frequency of 6.25 MHz. In a no-load operation, the master apparatus 12 transmits to the scanning apparatus 10, via the data stream, an endless no-load data stream, for example, with an endless sequence of the bit sequence 0101010101, for avoiding electric charging of the data line. At an unknown point of time, the master apparatus 12 sends a start byte, which comprises the bit sequence 0010111011 in the present exemplary embodiment, for signaling a subsequent data transmission. This start byte must be detected by the scanning apparatus 10 for signaling to a downstream external data evaluation apparatus 14 the beginning of the data transmission by providing a trigger signal A.

The scanning apparatus 10 comprises a detection unit 16, which is defined by an independent integrated circuit in the present exemplary embodiment, and a clock signal generator 18, which is defined by a microcontroller in the present exemplary embodiment. The detection unit 16 and the clock signal generator 18 are respectively provided with the data stream D.

The clock signal generator 18 generates a clock signal T1 which is synchronous but phase-shifted to the high-frequency serial data stream D. The clock signal T1 is provided to the detection unit 16. The clock signal T1 here has twice the frequency of the high-frequency serial data stream D, i.e., a frequency of 12.5 MHz. The higher frequency is required for ensuring a reliable start byte detection.

The detection unit 16 scans the high-frequency serial data stream D at the operating cycle of the clock signal T1, i.e., at a frequency of 12.5 MHz, for detecting a start byte in the data stream D. During a start byte detection by the detection unit 16, the external data evaluation apparatus 14 is provided with the trigger signal A by the detection unit 16. The detection unit 16 further provides a feedback clock signal T2 of half the frequency of the clock signal T1 to the clock signal generator 18 for improving the synchronization between the clock signal T1 and the data stream D.

The detection unit 16 in the present exemplary embodiment is defined by an independent logic detection circuit 19 which comprises only one shifting register element 20, four lookup table elements 22, 24, 26, 28 and an AND gate element 30, and a frequency divider element 32. The frequency divider element 32 is here provided with the clock signal T1 for generating the feedback clock signal T2 of half the frequency of the clock signal T1.

The shifting register element 20 comprises ten memory locations 20a-20j for buffering received data stream bits. The shifting register element 20 is provided with the high-frequency serial data stream D and the clock signal T1. The ten data stream bits received last are respectively buffered at each operating cycle in the memory locations 20a-20j of the shifting register element 20.

The first lookup table element 22 evaluates the contents of the first two memory locations 20a, 20b of the shifting register element 20 and compares them with the first two start byte bits (00). When both memory locations 20a, 20b each include a logic 0, the first lookup table element 22 outputs a logic 1.

The second lookup table element 24 evaluates the contents of the last three memory locations 20h-20j of the shifting register element 20 and compares them with the last three start byte bits (111). When all three memory locations 20h-20j each include a logic 1, the second lookup table element 24 outputs a logic 1.

The third lookup table element 26 evaluates the contents of three middle memory locations 20d-20f of the remaining five memory locations 20c-20g of the shifting register element 20 and compares them with the corresponding three start byte bits (011). When the memory location 20d includes a logic 0 and the memory locations 20e, 20f each include a logic 1, the third lookup table element 26 outputs a logic 1.

The fourth lookup table element 28 evaluates the output values of the first three lookup table elements 22, 24, 26 and outputs a logic 1 when at least two of the three output values include a logic 1.

The output value of the fourth lookup table element 28, together with the clock signal T1, is provided to the AND gate element 30 so that the trigger signal A is provided when the output value of the fourth lookup table element 28 includes a logic 1.

At least five memory elements of the ten memory elements 20a-20j, that is merely half of the memory locations 20a-20j, must comply with the corresponding start byte portion of the start byte to be detected. This allows for a fault-tolerant and thus particularly reliable start byte detection. The high-frequency detection apparatus here only comprises temperature-insensitive elements, in particular the detection apparatus according to the present invention does not comprise any addition blocks, whereby a reliable start byte detection even at high temperatures of up to approximately 115° C. is provided and whereby the detection circuit according to the present invention and thus the scanning apparatus 10 can be configured in a particularly inexpensive manner.

The present invention is not limited to embodiments described herein; reference should be had to the appended claims.

### LIST OF REFERENCE NUMERALS

10 Scanning apparatus
12 Master apparatus
14 Data evaluation apparatus
16 Detection unit
18 Clock signal generator
19 Independent logic detection circuit
20 Shifting register element
20a-20j Memory locations
22 First lookup table element
24 Second lookup table element
26 Third lookup table element
28 Fourth lookup table element
30 AND gate element
32 Frequency divider element
A Trigger signal
D High-frequency serial data stream
T1 Clock signal
T2 Feedback clock signal

What is claimed is:

1-6. (canceled)

7: A scanning apparatus for detecting a start byte in a high-frequency serial data stream, the scanning apparatus comprising:
a detection unit which is configured to detect the start byte in the high-frequency serial data stream, the detection unit consisting of an independent logic detection circuit which consists of temperature-insensitive circuit elements and which excludes addition blocks; and
a clock signal generator which is configured to provide the detection unit with a high-frequency clock signal which is synchronized to the high-frequency serial data stream, the high-frequency clock signal being provided with a frequency which is higher than a frequency of the high-frequency serial data stream.

8: The scanning apparatus as recited in claim 7, wherein the clock signal generator is provided as a microcontroller.

9: The scanning apparatus as recited in claim 7, wherein the independent logic detection circuit of the detection unit is provided as an integrated circuit.

10: The scanning apparatus as recited in claim 7, wherein the detection unit is configured to provide the clock signal generator with a feedback clock signal.

11: The scanning apparatus as recited in claim 7, wherein the temperature-insensitive circuit elements are provided as a shifting register element which comprises n memory locations and a plurality of lookup table elements.

12: The scanning apparatus as recited in claim 11, wherein the plurality of lookup table elements are configured so that a maximum of n−1 of the n memory locations of the shifting register element are evaluable.
